(19) United States
(12) Patent Application Publication
(10) Pub. No.: US 2015/0183194 A1
(43) Pub. Date: Jul. 2, 2015

(54) LAMINATED FABRIC SHIPPING SACKS, METHODS OF MANUFACTURING, AND RELATED SYSTEMS

(71) Applicant: Greif Flexibles Trading Holding BV, Leiden (NL)

(72) Inventors: Wolfgang Lehmann, Bad Duerrheim (DE); Roger Bannister, Bowling Green, KY (US)

(21) Appl. No.: 14/583,874

(22) Filed: Dec. 29, 2014

Related U.S. Application Data
(60) Provisional application No. 61/921,944, filed on Dec. 30, 2013.

(51) Int. Cl. B32B 27/12; B65D 30/08; B32B 37/00; B32B 37/18; B32B 27/32; B32B 37/10

(52) U.S. Cl. CPC B32B 27/12; B32B 27/32; B32B 37/1027; B32B 37/0053; B32B 37/182; B65D 29/02; B32B 2250/03; B32B 2250/246; B32B 2262/0253; B32B 2553/00

(57) ABSTRACT

A base fabric made of polypropylene and/or polyethylene tapes or fibers is laminated with a polyolefin film coating. The laminated fabric may be used to make a shipping sack.

### CROSS REFERENCES TO RELATED APPLICATIONS

This application claims priority from U.S. provisional application Ser. No. 61/921,944 filed on Dec. 30, 2013.

### FIELD

The present subject matter relates to coated fabrics bearing a laminated coating including polypropylene and high density polyethylene, and end products of commercial use involving such coated fabric in packaging applications, and applications such as tarpaulins or technical textiles. The present subject matter also relates to systems for producing such.

### BACKGROUND

Flexible intermediate bulk containers (FIBCs), more generally termed woven shipping sacks, utilize various fabrics (such as woven polypropylene, woven high density polyethylene and PVC coated fabrics), in various fabric weights together with sewing or sealing and gluing methods, depending on the necessary strength of the bag, its desired safety factor and the bag design. Such bags vary in size to generally hold from 0.5 to 120 cubic feet of material and up to about 6,000 pounds of product. They generally can be designed with various shaped tops suitable for filling, can have a solid bottom or a sewn-in discharge spout configuration, and can have lifting handles. For dry or fluidized products that require a more rigid bag for stability, solid support inserts may be placed inside the bag, and between the outer bag surface and a liner (if one is used) to provide the bag's sidewalls with greater rigidity.

A common drawback of flexible intermediate bulk containers (FIBC) is tensile failure or delamination of a coating. As will be understood, tensile failure can result in tears or openings in the container. And coating delamination can lead to loss of integrity or barrier properties of the container. Accordingly, a need exists for a laminated fabric that exhibits a relatively high tensile strength and/or resistance to coating delamination.

### SUMMARY

Many if not all of the drawbacks of the prior art are addressed by the subject matter, briefly described hereinbelow.

When a fabric of the present subject matter is used in shipping sacks or FIBCS or technical textiles like a tarpaulin, a cross-weave of different types of tapes increases tear strength of the fabric and as a result, strength of the packing or technical textile. Further, due to the material composition the adhesion of the coating is increased on part of the woven tapes, so that a delamination of the coating from the fabric is prevented or at least significantly reduced.

In one aspect, the present subject matter provides a laminated fabric comprising an HDPE-PP fabric comprising: (i) an HDPE blend tape and (ii) polypropylene tape. The laminated fabric also comprises a lamination layer comprising, (i) polypropylene copolymer having a MFI (230° C./2.16 kg) of 22-45, and (ii) a compatibilizer. And, the laminated fabric also comprises a polyolefin film layer. The lamination layer binds together the HDPE-PP fabric and the polyolefin film layer.

In one embodiment, the polyolefin film has a thickness of 8-50 microns. The polyolefin film layer in one embodiment may comprise at least one selected from the group consisting of biaxially oriented polypropylene, mono and biaxially oriented PE such as HDPE, LDPE or LLDPE, a cast film of at least one selected from the group consisting of LDPE, LLDPE, MDPE, HDPE, a blown film of at least one selected from the group consisting of LDPE, LLDPE, MDPE, and HDPE, and combinations of the foregoing.

In another aspect, the subject matter provides a laminated fabric including a cross woven HDPE blend fabric. The HDPE blend fabric includes a plurality of warp tapes and a plurality of weft tapes. At least one of (I) the plurality of warp tapes and (II) the plurality of weft tapes are cross-woven. At least a portion of the warp tapes comprise: (i) 90-100 wt % of a homopolymer or copolymer of polypropylene having a MFI (230° C./2.16 kg) of 1-6, (ii) 0-3 wt % of a first filler and (iii) 0-3 wt % of a first pigment. At least a portion of the weft tapes comprise: (i) 75-95 wt % HDPE, having a MFI (190° C./2.16 kg) 0.05-3, (ii) 10-25 wt % polypropylene homopolymer having a MFI (230° C./2.16 kg) of 1-7, (iii) 0-3 wt % of a second filler, and (iv) 0-3 wt % of a second pigment. In this paragraph, the compositional and property recitations of the warp and weft tapes may be reversed to form another embodiment of the subject matter.

In another aspect, the subject matter provides a method of making a laminated fabric comprising (I) cross-woven oriented polyolefin tapes and (II) a polyolefin film coating. The method comprises (a) providing a cross-woven HDPE blend fabric and a polyolefin film and (b) laminating onto at least one side of the blend fabric the polyolefin film at a temperature of 225-325° C. to form a laminated fabric.

In one embodiment, the method involves providing an HDPE blend fabric that comprises (I) providing at least one weft tape, (II) providing at least one warp tape, and (III) weaving a plurality of weft tapes and warp tapes into a woven fabric. Providing at least one weft tape comprises melt blending (i) 5-35 wt % 0.5-8 MFI (230° C./2.16 kg) polypropylene, (ii) 65-95 wt % 0.1-3.5 MFI (190° C./2.16 kg) high density polyethylene, (iii) 0-30 wt % of at least one filler, (iv) 0-3 wt % of at least one UV additive, and (v) 0-5 wt % of at least one compatibilizer to form a melt blend. Providing the at least one weft tape also comprises extruding the melt blend at 220-295° C. through a die to form an extrudate. Providing the at least one weft tape also comprises water quenching the extrudate. Providing the at least one weft tape also comprises slitting the extrudate to form at least one tape. Providing the at least one weft tape also comprises heating and stretching the at least one tape at 50-500 m/min and 80-140° C. Providing at least one warp tape comprises melt blending (i) 90-100 wt % 0.5-5 MFI (230° C./2.16 kg) polypropylene copolymer or polypropylene homopolymer, (ii) 0-10 wt % of at least one filler, (iii) 0-3 wt % of at least one UV additive, and (iv) 0-5 wt % of at least one compatibilizer to form a melt blend. Providing the at least one warp tape comprises extruding the melt blend at 220-295° C. through a die to form an extrudate. Providing the at least one warp tape comprises water quenching the extrudate. Providing the at least one warp tape comprises slitting the extrudate to form at least one tape. And, providing the at least one warp tape comprises heating and stretching the at least one tape at 50-500 m/min and 80-140° C.

In another aspect, the subject matter provides a laminated fabric comprising cross woven HDPE blend fabric, wherein the cross woven HDPE blend fabric comprises tapes in first and second directions. The tapes of the first direction comprise an oriented polyolefin tape comprising an extruded and stretched melt blend comprising (a) 5 to 35 wt % 0.5-8 MFI (230° C./2.16 kg) polypropylene, (b) 65 to 95 wt % 0.1-3.5 MFI (190° C./2.16 kg) high density polyethylene, (c) 0-30 wt % of at least one filler, (d) 0-3 wt % of at least one UV additive, and (e) 0-5 wt % of at least one compatibilizer to form a melt blend. The tapes of the second direction comprise a material which has a melt temperature different from the tapes of the first direction.

In another aspect, the subject matter provides laminated fabric comprising (I) cross-woven HDPE blend fabric laminated with (II) a lamination layer. The cross-woven HDPE blend fabric (I) comprises an oriented polyolefin tape comprising an extruded and stretched melt blend comprising (a) 5-35 wt % 0.5-8 MFI (230° C./2.16 kg) polypropylene, (b) 65-95 wt % 0.1-3.5 MFI (190° C./2.16 kg) high density polyethylene, (c) 0-30 wt % of at least one filler, (d) 0-3 wt % of at least one UV additive, and (e) 0-5 wt % of at least one compatibilizer to form a melt blend. The lamination layer or coating (II) comprises biaxially oriented low density polypropylene having a density of 0.70-0.90 g/cc.

In another aspect, the subject matter provides a method of making a laminated fabric comprising (I) cross-woven oriented polyolefin tape and (II) polyolefin film coating. The method comprises (a) providing a cross-woven HDPE blend fabric and a polyolefin film, and (b) laminating onto the fabric on at least one side of the fabric the polyolefin film at a temperature of 225-325° C. to form a laminated fabric.

In still another aspect, the subject matter provides a laminated fabric comprising (a) a cross woven HDPE blend fabric, and (b) a lamination layer. The lamination layer includes (i) polypropylene copolymer having a MFI (230° C./2.16 kg) of 22-45, and (ii) a compatibilizer. The laminated fabric also comprises (c) a tie layer, wherein the tie layer comprises at least one selected from the group consisting of HDPE, LLDPE, PP, LLDPE-EVA copolymer, anhydride-modified acrylate copolymer and anhydride-modified LLDPE.

In another aspect, the subject matter provides a laminated cross woven fabric comprising (a) a cross-woven HDPE blend fabric, and (b) a first lamination layer laminated to a first side of the HDPE blend fabric. The lamination layer comprises (i) 70-100% of 5-10 MFI (190° C./2.16 kg) LDPE or LLDPE, and (ii) 0-30% of 22-45 MFI (230° C./2.16 kg) polypropylene copolymer. The laminated cross woven fabric also comprises (c) a tie layer laminated to a second side of the blend fabric. The tie layer comprises: (i) 22-45 MFI (230° C./2.16 kg) polypropylene copolymer, (ii) a compatibilizer, and (iii) at least one selected from the group consisting of from the group consisting of HDPE, LLDPE, PP, LLDPE-EVA copolymer, anhydride-modified acrylate copolymer and anhydride-modified LLDPE. The laminated cross woven fabric also comprises (d) a polyolefin film layer bonded to the tie layer.

In another aspect, the subject matter provides a laminated cross woven fabric comprising (a) a cross-woven HDPE blend fabric, and (b) a lamination layer. The lamination layer comprises (i) 0-100% LDPE or LLDPE having a MFI (190° C./2.16 kg) of 5-10, (ii) 0-100% polypropylene copolymer having MFI (230° C./2.16 kg) of 22-45, (iii) 0-10% of a filler, (iv) 0-4% of a pigment.

In another aspect, the present subject matter provides a method for laminating a first film to a second film to form a composite laminated film. The method comprises simultaneously conveying a first film onto a nip roll and a second film onto a laminating roll. The method also comprises pressing the first film into contact with the second film between the nip roll and the laminating roll to form the composite laminated film. The composite laminated film has a first film side facing away from the laminating roll and a second film side in contact with the laminating roll. The method also comprises conveying the composite laminated film from the laminating roll onto an intermediate roll, wherein the first film side contacts the intermediate roll and the second film side faces away from the intermediate roll. The method additionally comprises conveying the composite laminated film from the intermediate roll onto a return roll, wherein the second film side contacts the return roll and the first film side faces away from the return roll. The method also comprises conveying the composite laminated film from the return roll onto the laminating roll, wherein the second film side contacts the laminating roll and the first film side faces away from the laminating roll. And the method also comprises conveying the composite laminated film from the laminating roll onto a discharge roll, wherein the first film side contacts the discharge roll and the second film side faces away from the discharge roll.

In any aspect of the present subject matter, any disclosed film may be interchanged with any disclosed fabric.

In still another aspect, the present subject matter provides a film lamination station comprising a nip roll, a laminating roll, an intermediate roll, a return roll, and a discharge roll. The nip roll is configured to press a first film conveyed thereon into contact with a second film conveyed by the laminating roll to form a composite laminated film having a first film side facing away from the laminating roll and a second film side in contact with the laminating roll. The intermediate roll is configured to receive the laminated film from the laminating roll with the first film side in contact with the intermediate roll and the second film side facing away from the intermediate roll. The return roll is configured to receive the laminated film from the intermediate roll with the second film side in contact with the return roll and the first film side facing away from the return roll. The laminating roll is configured to receive the laminated film from the return roll with the second film side in contact with the laminating roll and the first film side facing away from the laminating roll. The discharge roll is configured to receive the laminated film from the laminating roll with the first film side in contact with the discharge roll and the second film side facing away from the discharge roll.

In yet another aspect, the present subject matter provides a shipping sack comprising any laminated film or fabric disclosed herein.

In still another aspect, the present subject matter provides a shipping sack comprising a laminated fabric, laminated film, or composite laminated film made by any method disclosed herein.

In yet another aspect, the present subject matter provides a laminated fabric or composite laminated film made by any film lamination station or operation disclosed herein.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic depiction of a lamination station roller assembly involved in producing the laminated fabrics or composite laminated films of the subject matter.

### DETAILED DESCRIPTION OF THE EMBODIMENTS

In many applications, a standard PP or HDPE fabric when laminated loses approximately 50% of its tear strength. It has been discovered that by cross weaving HDPE blend tapes and PP tapes the tear strength of a fabric can be maintained after coating. This allows the production of high tear resistant coated fabrics. FIBCs may normally be coated with either PP or HDPE, but a coating on a standard fabric normally leads to a loss in tear strength of about 50%.

The loss in tear strength is even greater (about 80%) if a BOPP film or other polyolefin film is coated onto a standard PP or HDPE fabric. It has been discovered that by cross weaving HDPE blend tapes and PP tapes the tear strength of a fabric which is coated with BOPP film or other polyolefin film can be maintained.

A roller configuration has been developed for a coating line which applies a polyolefin coating (such as BOPP) to a fabric. The roller configuration allows laminated fabric to cool quickly after the coating process. On current systems the cooling of the fabric takes place through the polyolefin (BOPP) and a tie layer, while on the new system in accordance with the present subject matter, the cooling is done directly on the fabric side. This leads to higher strength coated fabric, as the orientation of the molecules in the fabric tapes is directly correlated with the time the fabric stays hot after the coating process.

An embodiment of the subject matter is a method for laminating a first film to a second film to form a composite laminated film. The method comprises simultaneously conveying a first film onto a nip roll and a second film onto a laminating roll. The method also comprises pressing the first film into contact with the second film between the nip roll and the laminating roll to form the composite laminated film. The composite laminated film has a first film side facing away from the laminating roll and a second film side in contact with the laminating roll. The method additionally comprises conveying the composite laminated film from the laminating roll onto an intermediate roll, wherein the first film side contacts the intermediate roll and the second film side faces away from the intermediate roll. The method also comprises conveying the composite laminated film from the intermediate roll onto a return roll, wherein the second film side contacts the return roll and the first film side faces away from the return roll. The method also comprises conveying the composite laminated film from the return roll onto the laminating roll, wherein the second film side contacts the laminating roll and the first film side faces away from the laminating roll. The method also comprises conveying the composite laminated film from the laminating roll onto a discharge roll, wherein the first film side contacts the discharge roll and the second film side faces away from the discharge roll.

In the lamination method, the laminating roll may have a larger, smaller or the same diameter as the intermediate roll. In many embodiments, the laminating roll has a larger diameter than the intermediate roll. Further, the return roll may have a larger, smaller, or the same diameter as the intermediate roll. In many embodiments, the return roll has a smaller diameter than the intermediate roll.

In the methods, any combination of films and/or fabrics and/or coatings disclosed elsewhere herein may be laminated together.

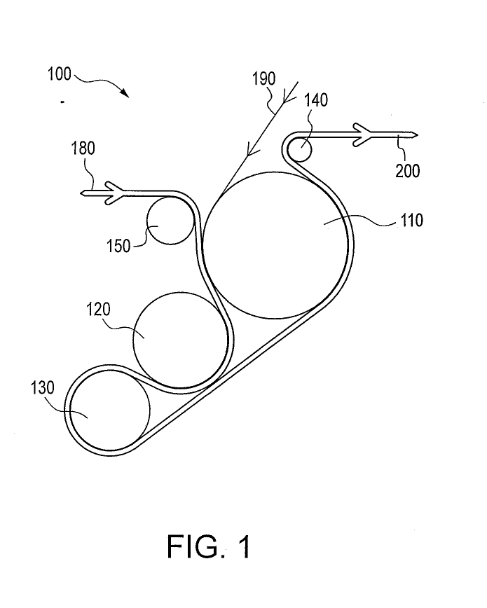

Referring now to FIG. 1, a portion of a lamination station 100 useful in applying the lamination methods of the subject matter is depicted. Lamination station 100 includes a laminating roll 110, an intermediate roll 120, a return roll 130, a discharge roll 140, and a nip roll 150. A first film 180 and a second film 190 are laminated together to form a laminated fabric or composite laminated film 200. It is understood that first film 180 and second film 190 can be any film or fabric disclosed elsewhere herein.

An embodiment of the present subject matter is a film lamination station or system comprising a nip roll, a laminating roll, an intermediate roll, a return roll, and a discharge roll. The nip roll is configured to press a first film conveyed thereon into contact with a second film conveyed by the laminating roll to form a composite laminated film having a first film side facing away from the laminating roll and a second film side in contact with the laminating roll. The intermediate roll is configured to receive the laminated film from the laminating roll with the first film side in contact with the intermediate roll and the second film side facing away from the intermediate roll. The return roll is configured to receive the laminated film from the intermediate roll with the second film side in contact with the return roll and the first film side facing away from the return roll. The laminating roll is configured to receive the laminated film from the return roll with the second film side in contact with the laminating roll and the first film side facing away from the laminating roll. The discharge roll is configured to receive the laminated film from the laminating roll with the first film side in contact with the discharge roll and the second film side facing away from the discharge roll.

In the film lamination station, the laminating roll may have a larger, smaller or the same diameter as the intermediate roll. In many embodiments, the laminating roll has a larger diameter than the intermediate roll. Further, the return roll may have a larger, smaller, or the same diameter as the intermediate roll. In many embodiments, the return roll has a smaller diameter than the intermediate roll.

In the film lamination station or any method herein, any of the rolls mentioned herein may be chilled or cooled, namely any of the nip roll, the laminating roll, the intermediate roll, the return roll and/or the discharge roll, in any combination.

In one embodiment, at least one of the intermediate roll and the return roll may be cooled. In one embodiment both the intermediate roll and the return roll are cooled.

Using the film lamination station, any combination of films and/or fabrics and/or coatings disclosed elsewhere herein may be laminated together.

The coated and/or laminated fabrics of the subject matter can be fabricated into containers such as bags, including FIBC bags, shipping sacks and dunnage bags. Other useful products may be provided such as ground cover; geotextiles, such as those used to line waste dumps, holding ponds and settling ponds; and tarpaulins, straps and ropes can be made from the coated fabrics of the subject matter. These various fabrics and other products produced in accordance with the present subject matter have an improved hand and fabric softness which will be an improvement in the perception of the fabric and bags and other articles of commerce produced from the fabric. The present subject matter can also provide efficiency improvement in the bag fabrication step, in terms of time, to make the bag, and safety, from the use of less rigid fabric.

In one embodiment of the subject matter, a cross woven HDPE blend fabric is coated with BOPP film, which is attached by a coating process, in effect creating a fabric with the following layers: (1) cross woven HDPE Blend fabric, (2) laminate (PP+LDPE or PP+LLDPE)+compatibilizer (such as Polybond), and (3) BOPP.

Additionally, the cross woven HDPE blend fabric can be coated (laminated) on the other side with LDPE or PP copolymer, so the following layers can be created: (1) LDPE or PP copolymer laminate, (2) cross woven HDPE Blend fabric, (3) laminate (PP+LDPE or PP+LLDPE)+compatibilizer (such as Polybond), and (4) BOPP. Restated, a second lamination layer comprising LDPE or LLDPE or PP copolymer may be laminated directly to the HDPE blend fabric. Such lamination is not possible with a PP fabric.

As an additional feature it is possible to add single PP tapes into the HDPE blend fabric in the HDPE blend tape direction. The coating will have different adhesion properties to these tapes, so it is possible to create a ripping barrier for the fabric at these additional tapes.

An embodiment of the subject matter is a cross woven fabric with different plastic or thermoplastic materials in first and second directions (for example warp and weft directions) which have different melting temperatures. The melt temperature of the materials (plastics or thermoplastics), such as tapes, of the first direction can be 100 to 136° C., while the melt temperature of the materials of the second direction can be 137° C. to 270° C. The skilled artisan will immediately envision plastics and/or thermoplastics having melt temperatures in these ranges. In one embodiment, a fabric of the subject matter may include tapes in a first direction having a lower melting temperature than the tapes in a second direction. In another embodiment, a fabric of the subject matter may include tapes in a first direction having a higher melting temperature than the tapes in a second direction.

The different materials exhibit different adhesion of the coating on the surface. When a tear force is applied to the material the coating may loosen from one of the cross woven materials while still having a strong adhesion to the second material. The tapes which delaminate (lose adhesion) cause a strong resistance against tearing as the tapes getting loose inside the weave and several loose tapes crumble with each other which then results in a very high tear strength while the fabric still holds together as the second material still bonds as it still has the coating layer attached.

The high adhesion of the laminate is developed because the cross-weave (especially an HDPE blend) can be coated at a higher temperature to achieve better sealing properties.

The higher coating temperature is possible as the HDPE blend maintains oriented PP fibrils (as disclosed in commonly owned U.S. application Ser. No. 13/550,637 incorporated by reference herein), even when the HDPE is losing the orientation of the HDPE molecules by the heat of the coating process. Additionally in the cross weave the HDPE tapes at least partially (up to about 50%) protect the PP copolymer tapes. Thus, even when a higher coating temperature is used less heat is applied on average to the PP copolymer tapes. Therefore, the PP copolymer maintains a higher orientation than in a standard coating process.

The bags made from the fabric of the blended tapes have a broader usable temperature range for customer use than either the PP or PE only bags. The HDPE blend of the present subject matter has a wider processing temperature window (during coating) which leads to a higher strength than either purely HDPE fabric or purely PP fabric. In particular this will provide benefits for high temperature filling of pure PE bags and low temperature storage and usage of PP only bags.

The fabrics and containers of the present subject matter may also be made electrically conductive. For instance, any cloth herein may further comprise electrically conductive filaments including conductivity increasing additives to render the product electrically conductive. The conductivity increasing additive(s) may include at least one of carbon black, graphite, a metal such as silver, platinum, copper, aluminum, and others, an intrinsically conducting polymer (ICP) such as polyaniline, polyacetylene, polyphenylene vinylene, polythiophene, polyphenylene sulfide, and others. Combinations of these additives can also be used.

Due to the superior tear strength observed for the laminated fabrics of the present subject matter, it should be possible to decrease the thickness of the underlying fabric while matching the existing physical property requirements of FIBC bags currently used. Alternatively, the strength of the bags may be increased at constant fabric thickness or density allowing a producer to develop new customer end-use applications.

Broadly, the present subject matter relates to a laminated base fabric. The base fabric includes at least one of polypropylene and/or polyethylene each in any density range. The fabric is laminated with a polyolefin film like biaxially oriented polypropylene film. While nearly any combination of polypropylene and polyethylene in the base fabric can be used, the polyolefin film coating may include optional compatibilizers, and optional fillers such as reinforcing fillers, and UV additives. Use of the laminated fabrics of the subject matter is envisioned also. The present subject matter includes a process of making a laminated fabric. Each component, process, and use is described herein.

Polypropylene. Various components of the subject matter include at least one of a polypropylene copolymer (PPCP), polypropylene homopolymer (PPHP), and polyolefin films like biaxially oriented polypropylene (BOPP), which in turn may be homopolymers, copolymers, or terpolymers. The densities of polypropylene useful herein may be 0.725-0.92 g/cc, in many embodiments 0.75-0.915 g/cc and more particularly 0.775-0.91 g/cc. In an alternate embodiment, the polypropylene density may be 0.89-0.92 g/cc, in many embodiments 0.895-0.915; and particularly 0.9-0.925 0.905-0.92; 0.905-0.915, and 0.905-0.910.

Polypropylene Copolymer (PPCP). The polypropylene copolymer useful herein has a melt flow index (MFI) at 230° C./2.16 kg of 15-55, in many embodiments 20-50, and particularly 22-45. Alternate embodiments may have a MFI at 230° C./2.16 kg of 17-47, 25-42 or 27-37. Still other embodiments may have a MFI at 230° C./2.16 kg of 19-51, 21-49 or 23-46. The Melt Flow Index (MFI), or Melt Flow Rate (MFR), (used interchangeably) is determined according to ISO 1133, or ASTM 1238-04c, “Standard Test Method for Melt Flow rates of Thermoplastics by Extrusion Plastometer,” as known in the art.

Polypropylene Homopolymer (PPHP). The polypropylene homopolymer useful herein has a melt flow index (MFI) at 230° C./2.16 kg of 0.5-8, in many embodiments 1-7, and particularly 1.2-6; 1.5-4; 1.6-3; 1.7-2.5; and 1.8-2.2. In certain embodiments, the PPHP MFI is 1.9-2.1. When other sources of polypropylene are used, useful alternate polypropylene MFIs include 2.2-3.8 and particularly: 2.4-3.6; 2.6-3.4; and 2.8-3.2. In this alternate embodiment, a particular polypropylene MFI is 2.9-3.1. The density of polypropylene useful herein may be 0.725-0.93 g/cc, in many embodiments 0.75-0.915 g/cc and particularly 0.775-0.91 g/cc. In an alternate embodiment, the polypropylene density may be 0.89-0.92 g/cc, particularly 0.895-0.915; and more particularly: 0.9-0.925; 0.905-0.92; 0.905-0.915, and 0.905-0.91. Suitable polypropylenes herein include those sold under the Mosten™ trademark from Unipetrol Deutschland GmbH such as Mosten™ TB002 and Reliance H030SG, available from Reliance Industries Ltd, as well as other polypropylene products commercially available.

Polyolefin films. Polyolefin films can be any film made in the thickness between 8 and 50 micrometers made of LDPE, LLDPE, MDPE, HDPE, PP with a MFI between 0.05 and 5 and can include compatibilizers like EVA, EVOH. The film can be produced either as cast extrusion film, blown film or single or bioriented film. A particular embodiment of PP is a biaxially oriented polypropylene (BOPP). The BOPPs useful in the subject matter may be homopolymers, copolymers, or terpolymers. In general, the BOPPs useful herein have a melt flow index (MFI) at 230° C./2.16 kg of 1-10; in many embodiments 1.5-8; and particularly 1.7-6; 1.8-5; and 2-4.5. Densities may be 0.7-0.92 g/cc, in many embodiments 0.725-0.915 g/cc, and particularly 0.75-0.91 g/cc.

In alternate embodiments, the different types of BOPPs may have different MFI ranges. For example, homopolymer BOPPs may have a MFI at 230° C./2.16 kg of 1.5-4, particularly 2-3.5, and more particularly 3.1-3.7. Copolymer BOPPs have a MFI at 230° C./2.16 kg of 1-3.5, in many embodiments 1.3-2.9, particularly 1.5-2.2, and more particularly 1.6-2.1. Terpolymer BOPPs may have a MFI at 230° C./2.16 kg of 3-10, in many embodiments 4-9, and particularly 5-7. The BOPP coating may be laminated to any fabric herein at a temperature of 150-330° C.

Suitable BOPPs useful herein include those sold under the Borclean™ Bormed™ and Borseal™ trademarks, including the following Borclean™ product numbers: HB311BF, HC312BF, HC314BF, HC318BF, HC300BF. The following Borseal trademarked products TD210BF, TD215BF, and TD220BF are suitable. Bormed™ TD109CF is suitable. Borealis products HC101BF, HC110BF, and RB501BF are also suitable. All products in this paragraph are available from Borealis AG.

Generally, polypropylenes made by Ziegler-Natta or metallocene catalysis and in combination with any co-catalyst, modifiers and/or catalyst support are suitable in the present subject matter. Any known polymerization technique may be used to produce the polypropylenes useful in the subject matter, for example bulk, gas phase and bulk/gas combination polymerization. Commercial manufacturers and/or sellers of polypropylene useful herein include from Saudi Basic Industries Corporation (Sabic); LyondellBasell Industries, Braskem, Mitsui Chemical, Inc., ExxonMobil Chemical, Borealis AG; Unipetrol Deutschland, GmbH, Reliance Industries, Ltd., and others.

High Density Polyethylene (HDPE). The high density polyethylenes useful herein have a melt flow index at 190° C./2.16 kg of 0.1-3.5, and typically 0.15-3. The HDPE MFI is in many embodiments 0.17-2.5; 0.17-2; 0.17-1.5; and 0.17-1.25. Most particularly, the HDPE MFI is 0.17-0.95. Alternate embodiment HDPEs have a MFI at 190° C./2.16 kg of 0.01-4, in many embodiments 0.25-3.5, particularly 0.05-3, and still more particularly 0.10-2.5. The density of high density polyethylene useful herein is 0.941-0.997 g/cc, and particularly 0.943-0.985; 0.947-0.980; 0.950-0.975; and 0.953-0.970. In certain embodiments HDPE with a density of at least 0.955 g/cc is useful. In any embodiment herein the HDPE blend fabric may be woven or nonwoven. High density polyethylene made by Ziegler-Natta, chromium or metallocene catalysis and in combination with any co-catalyst, modifiers and/or catalyst support are suitable in the present subject matter. Any known polymerization technique may be used to produce the polyethylene useful in the subject matter, for example gas phase, slurry and solution polymerization.

Commercial manufacturers and/or sellers of high density polyethylene useful herein include Saudi Basic Industries Corporation (Sabic), LyondellBasell Industries, Borealis AG, ExxonMobil Chemical, Chevron Phillips Chemical, INEOS Polyolefins, TVK Polska, Slovnaft and others. Specific suitable high density polyethylenes include those sold under the Sabic™, Basell™, Tipelin™ and Borealis™ trademarks from the companies of the same names above, for example, Sabic™ FO4660, and Borealis™ VS5580 as well as and other high density polyethylene products commercially available.

MDPE. Medium Density Polyethylene. Various components of the present subject matter fabrics may additionally include medium density polyethylene (MDPE) which have densities in the range of 0.92-0.95 g/cc, in many embodiments 0.925-0.945 g/cc, and particularly 0.926-0.94 g/cc. Suitable MDPEs have MFI (190° C./2.16 kg) of 1-15, in many embodiments 2-13, more particularly 3-10, and more particularly 4-9. The lamination layers and/or the tie layers of the subject matter may include MDPE in amounts of 1-50 wt %, typically 5-25 wt %, and in certain embodiments 10-20 wt % of the respective fabric or layer composition.

LDPE and LLDPE. Various components of the present subject matter fabrics may additionally include low density polyethylene (LDPE) and/or linear low density polyethylene (LLDPE), which have MFI (190° C./2.16 kg) of 1-15, typically 2-13, more particularly 3-10, and in certain versions 4-9. The lamination layers and/or the tie layers of the subject matter may include at least one of LDPE and LLDPE in amounts of 1-50 wt %, in many embodiments 5-25 wt % and particularly 10-20 wt % of the respective fabric or layer composition.

PET. Polyethylene terephthalate may be used in certain embodiments herein. PET is a thermoplastic polymer resin of the polyester family. PET has a density in the range of 1.30-1.5 g/cc, and various morphologies have densities in g/cc of 1.37, 1.38, and 1.455 as well as melting temperatures of 240-270° C., for example 250° C. or 260° C.

Nylon. A variety of nylons can be used in certain embodiments of the subject matter. For example nylon-6,6; nylon-6; nylon-6,9; nylon-6,10; nylon-6,12; nylon-11; nylon-12 and nylon-4,6. Nylons have melt points of 190 to 350° C.

Tie Layer. A tie layer may be used in various regions of the fabrics such as laminated to a second side of the blend fabric. The tie layer may include any polypropylene copolymer (PPCP) as disclosed elsewhere herein. In many embodiments, the tie layer comprises at least one selected from the group consisting of HDPE, LLDPE, PP, LLDPE-EVA copolymer, anhydride-modified acrylate copolymer and anhydride-modified LLDPE. In particular embodiments, the tie layer comprises at least one of an anhydride-modified acrylate copolymer and anhydride-modified LLDPE, wherein the anhydride is selected from the group consisting of acetic anhydride, maleic anhydride and an anhydride having the formula R¹—C(═O)OC(═O)—R² wherein R¹ and R² are independently C₁-C₁₀ hydrocarbon chains. In particular embodiments, the tie layer comprises (a) 60-70 wt % polypropylene copolymer having a MFI (230° C./2.16 kg) of 22-45; (b) 10-20 wt % LDPE having a MFI (190° C./2.16 kg) of 3-10; and (c) 15-25 wt % of a compatibilizer.

Fillers, pigments and additives. A variety of fillers, pigments and additives can be used in producing the laminated fabrics of the present subject matter. Foremost among the additives are plasticizers and compatibilizers and fillers like CaCO₃ and pigments like TiO₂.

In certain embodiments, compatibilizers can be used such as those sold under the POLYBOND® name, including POLYBOND® 3000, which is 1.2% maleic anhydride modified polyethylene, having a MFI (190° C./2.16 kg) of 400 g/10 min. Other POLYBOND™ products useful herein include product numbers 1009, 3200, 3249, 6009, 6029, and POLYBOND™ 7200. It is noted that Polybond products include a majority of renewable feedstocks.

Further suitable compatibilizers are sold by Exxon under the Vistamax™ name. VistaMaxx products are propylene-based olefinic elastomers produced using ExxonMobil Chemical's proprietary metallocene catalyst technology. VistaMaxx™ product numbers including 2330, 3000, 3020FL, and 6202, are useful in many embodiments. The Vistamaxx™ compatiblizers have densities in the range of 0.85-0.90 g/cc, with values of 0.873, 0.863, 0.862 being exemplified. The Vistamaxx™ compatibilizers have a MFI (190° C./2.16 kg) in the range of 1-10, with 1.4, 3.6, 9.1 being exemplified.

Plasticizers include phthalate esters, diisononyl phthalate, bis(2-ethylhexyl) phthalate, di-n-butyl phthalate, butyl benzyl phthalate, diisodecyl phthalate, di-n-octyl phthalate, diisooctyl phthalate, diethyl phthalate, diisobutyl phthalate, and di-n-hexyl phthalate. Succinates are also envisioned including diisononyl succinate, bis(2-ethylhexyl) succinate, di-n-butyl succinate, butyl benzyl succinate, diisodecyl succinate, di-n-octyl succinate, diisooctyl succinate, diethyl succinate, diisobutyl succinate, and di-n-hexyl succinate.

Plasticizers may be added at amounts of 0.1-25 wt %, in many embodiments 0.5-10 wt % and particularly 3-8 wt %.

Fillers are added to change physical properties of a thermoplastic material, such as whiteness, coefficient of friction, and stiffness. Filler materials useful in the present subject matter include hard clays, soft clays, chemically modified clays, mica, talc, calcium carbonate, dolomite, titanium dioxide, amorphous precipitated hydrated silica, alumina and mixtures thereof. Other filler materials are known in the art such as CaCO₃. CaCO₃ masterbatch concentrates in a polyolefin such as polyethylene or polypropylene are suitable in the present subject matter.

Pigments (organic or inorganic) may be included to color the tapes or fabrics of the subject matter as desired. Useful inorganic pigments include antimony oxide, titanium dioxide, iron oxide, zinc chromate, zinc oxide, zinc sulfide, cadmium sulfides, chromium oxides and sodium aluminum silicate complexes. Examples of organic type pigments include azo and diazo pigments, carbon black, phthalocyanines, quinacridone pigments, perylene pigments, isoindolinone, anthraquinones, thioindigo and solvent dyes. Pigments may be included in the compositions of the tapes or lamination layers or tie layers herein at amounts of 0.1-10 wt %, in many embodiments 0.5-8 wt %, and particularly 1-5 wt %.

Flame retardant fillers may be used. Useful flame retardant fillers include bayerite aluminum hydroxide, gibbsite aluminum hydroxide, boehmite, magnesium hydroxide, phosphorus or organophosphorus compounds, melamine cyanurate, antimony oxide; and/or halogenated organic compounds such as dipentaerithritol, tetrabromobisphenol A carbonate oligomer, brominated polystyrene, melamine cyanurate, brominated phenoxy polymers, dioctyl tetrabromo terephthalate, decabromodiphenyloxide, tetrabromobisphenol A, brominated polymeric epoxy, polydibromophenylene oxide, and others. Flame retardants may be used in an amount of up to 5 wt %, alternately 0.1-5 wt %, alternately 0.5-3 wt %, and alternately 1-2.5 wt %.

Functional additives may be included in the melt blend to impart desired properties to the final extruded tape or cloth made therefrom.

One type of additive, UV additives also known as UV inhibitors, serve to limit or eliminate the detrimental effects of high-energy ultraviolet radiation on thermoplastic compositions by absorbing the radiation. The tapes of the subject matter typically include, at the melt-blend stage, up to 3 wt % of at least one UV additive.

UV additives useful in the practice of the present subject matter include hindered amines, substituted hydroxyphenyl benzotriazoles, carbon black, benzophenone, barium metaborate monohydrate, various phenylsalicylates, nickel dibutyl dithiocarbamate, phenylformamidine, titanium dioxide, and others. The inventors herein have found that the polymer blend of the subject matter requires less UV additive to achieve similar or superior UV resistance to prior art polymer blends. The polymer blends of the present subject matter can require as much as 10% less, and in many embodiments 20% less, 30% less, and 40% less UV additive than prior art blends. In certain versions, preferably, 50% less UV additive is required, as compared to a similar composition including polypropylene.

Fillers and additives can be added directly to a melt blend (neat), or as is commonly practiced, added in a masterbatch form that contains a polyolefin “carrier” that can be added to the melt blend. Fillers and additives may be added in the extruder. In the masterbatch, a PP or PE carrier, containing between 10-80% of the filler or additive, is used to deliver the filler or additive to the melt blend.

Accordingly, the melt blend may include 0-30 wt % of at least one filler, alternately 0-20 wt %. Other alternate ranges of filler that are useful include 0.1-20 wt %, 0-15 wt %, 0.1-15 wt %, 2-6 wt %, 1.6-4.8 wt %, 0-5 wt %, 0.1-5 wt %, 0.1-4 wt %, 2-4 wt %, 2-3 wt %, 0.5-3.5 wt %, 0.75-3.5%, and 1-3 wt %. Fillers may be added neat or as masterbatch. Useful fillers include CaCO₃.

Additives, such as UV additives, additives useful herein may be delivered neat or in a masterbatch as discussed for fillers hereinabove. Tapes of the subject matter typically include, at the melt-blend stage, up to 3 wt % of at least one additive, for example 0.1 to 3 wt %. Other alternate or particular ranges of additives include 0.1 to 2.5 wt %, 0.75-2 wt %, 0-1 wt %, 0.05-0.4 wt %, 0.05-1 wt %, 0.075-0.75 wt %, 0.1-0.5 wt %, 0.08-0.15 wt %. In another embodiment, the melt blend may contain no greater than 0.2 wt % neat of an additive such as a UV additive.

For all additives and fillers noted herein, it is envisioned, that any amount listed, whether delivered as masterbatch or neat, may be delivered in the other form to provide the same ultimate amount of active ingredient. For those ranges of fillers and additives not specified as masterbatch or neat, the presumption is that the filler is added neat.

A melt blend for lamination is produced by charging the extruder with a mixture of solid pellets which are melted and blended by the extruder. The extruder may be single screw or twin screw. The extruder typically includes at least one of each of filter, melt pipe and die, such as a slot die. Melt pipes and dies are set to temperature ranges as described herein. Useful extruders, include those commercially available from Starlinger GmbH, Vienna, Austria, Bag Solutions Worldwide, Vienna Austria, or Yong Ming Machinery Manufacturing Co., Ltd, China.

Lamination extruders may be coextruders, in which a center layer can be PP copolymer or LDPE or HDPE or a blend of the materials, while the outside layers can carry additional antiblock, plasticizers and compatibilizers.

Extruder screw speeds can vary, but are typically 25-250 rpm, in certain embodiments 50-200, particularly 75-175 rpm, and more particularly 100-150 rpm. A slot die has a slot gap of 0.1-3 mm, typically 0.2-1.5 mm, in many embodiments 0.25-1.0 mm, particularly 0.3-0.7 mm, and more particularly 0.4-0.7 mm. In other embodiments, the die gap is 0.01 to 0.1 inches (0.254 to 2.54 mm).

Exemplary fabrics: For the testing carried out as detailed below, the following fabric was formulated: 83 gram blend fabric (grams/m²) having BOPP applied thereto at a thickness of 70 mil (equivalent to 15 grams/m²). The fabric is cross woven HDPE blend fabric in which the weft tape is HDPE blend tape including 15% PP homopolymer, 1.5% CaCO₃, 0.5% TiO₂, and 83% HDPE and the warp tape is PP copolymer tape including 98% PP copolymer, 1.5% CaCO₃, and 0.5% TiO₂. Onto the cross woven HDPE blend fabric, 20 grams of coating are applied to each square meter of the fabric, the coating including 22 wt % POLYBOND 3000 or POLYBOND 7200; 63 wt % polypropylene and 15 wt % LDPE.

Production parameters. The lamination is undertaken at a rate of 20 grams/m². The die width is 1290 mm with a cloth width of 1000 mm. The roller and die temperatures were as follows in Table 1. The melt temperature was 263° C. Other lamination line parameters are shown in Tables 2 and 3.

TABLE 1
Lamination Cylinder and Die Parameters

| Temperature (° C.) | Set Point | Actual | | Set Point | Actual |
|---|---|---|---|---|---|
| Cylinder Z1 | 245 | 244 | Die Z21 | 270 | 270 |
| Cylinder Z2 | 250 | 246 | Die Z22 | 270 | 270 |
| Cylinder Z3 | 250 | 250 | Die Z23 | 270 | 270 |
| Cylinder Z4 | 255 | 255 | Die Z24 | 270 | 270 |
| Cylinder Z5 | 260 | 261 | Die Z25 | 270 | 270 |
| Cylinder Z6 | 260 | 262 | Die Z26 | 270 | 270 |
| Cylinder Z7 | 270 | 270 | Die Z27 | 270 | 270 |
| Cylinder Z8 | 270 | 270 | Die Z28 | 270 | 277 |
| Screen Z11 | 265 | 263 | | | |
| Mixer Z14 | 265 | 263 | | | |
| FEEDSECT | 50 | 72 | | | |
| Oilheater 1 | 70 | 70 | | | |
| Block Z13 | 265 | 261 | | | |
| Laminator | 12 | 18 | | | |

TABLE 2
Lamination Line Speed Parameters

| | | | | | |
|---|---|---|---|---|---|
| Extruder | 297 | rpm | Line Speed | 200 | m/min |
| Pre Heating Roll | 199.9 | m/min | Laminator | 200 | m/min |
| Winder | 199.34 | m/min | Cloth Tension | 68 | kg |

| | | | |
|---|---|---|---|
| Pressure Pre | 1.5 | Pressure Main | 2.5 |
| Winding | | Winding | |

TABLE 3
Lamination Line Pressure Parameters

| | | | |
|---|---|---|---|
| P Screen | 148 bar | P Die | 54 Bar |

Testing Procedure. Two test procedures are used to test the shipping sack fabric of the subject matter, as shown in Table 4 below: (1) Tear strength test and (2) Peeling test. Tear strength is required, so that shipping sacks do not break when they are pulled down from racks or pallets which may have sharp edges. Further, a high tear strength is necessary when shipping sacks are dropped to avoid breakage. Peeling strength is required to achieve a strong seal with the fabric when welding it together to a shipping sack. With a low peeling strength, the welding of the bag will break easily so the shipping sacks would break easily when dropped or handled.

Test Strength Test Procedure. A 80 mm wide and 300 mm long piece of fabric is cut out in machine and cross machine direction.

A 100 mm long cut is then made into the fabric. The sample is then clamped into a tensile tester. The test is started and the sample is torn at a test speed of 100 mm/min. The tearing test continues until maximum tensile strength is measured and tensile strength does not increase any further while tearing test is ongoing. A 25 mm wide and 300 mm long sample is cut from the fabric coated with BOPP. Then a strong adhesion tape is glued on the BOPP side onto the BOPP coated fabric. The tape is RQ-20130YLW manufactured by ROCO of Korea. The BOPP on the side is not laminated onto the fabric to allow the test specimen to be taken.

The BOPP with the glued on tape is then input into 1 side of the tensile tester and the fabric into the opposite side of the tensile tester. Then the peeling test is performed with a speed of 100 mm/minute.

The peeling test is continuous until constant tensile strength is measured and a continuous peeling takes place. Note is taken as to whether the adhesion coating layer remains on the fabric (higher bonding strength to the fabric) or on the BOPP film (higher bonding strength of adhesion coating onto BOPP).

The inventors of the present subject matter herein have made several discoveries regarding the performance of the noted fabrics. It was seen that any additive which increases the bonding of the laminate to only one of the fabric materials will strongly improve the strength of the coated fabric and make the strength results more consistent. For example Polybond increases the adhesion to PP without increasing the adhesion to the HDPE. Tear tensile was always stronger in the weft direction because the tear was across the HDPE tapes allowing movement and stretch in the tapes. The HDPE withstood the heat better allowing it to have less damage by heat. Useful lamination/coating temperatures are 230-300° C., in many embodiments 240-290° C., and particularly 270-280° C. The colder the chill roller (leading to more rapid cooling of the fabric) the better the strength, which are important considerations in machinery/roller design.

It is noted that in Run 15 the BOPP did not separate at all during the tear force test. BOPP broke in small pieces (about 4 mm×4 mm) fracturing in the weave pattern.

TABLE 4
Test results of Prior Art and Inventive Coated Fabrics

| | | | Average | Average | | | |
|---|---|---|---|---|---|---|---|
| | | | Strength | Strength | | | |
| | | | Warp | Weft | Peeling | | Coating |
| Run | Warp Material | Weft Material | Tear Test | Tear Test | Test | Machine Parameters | Additive |
| 1 | PP Homopolymer | PP Homopolymer | 20-50N | 20-50N | not tested | not tested | n/a |
| 2 | PP Copolymer | PP Copolymer | 160N | 140N | 4.58N | speed 150 m/min, | Polybond |
| | | | | | | rubber roll pressure 7 | 3000 |
| | | | | | | bar, Corona 2.5 kW, | |
| | | | | | | die temp. 260° C. | |
| 3 | HDPE Blend | HDPE Blend | 150N | 150N | 4.22N | speed 150 m/min, | Polybond |
| | | | | | | rubber roll pressure 7 | 3000 |
| | | | | | | bar, Corona 2.5 kW, | |
| | | | | | | die temp. 260° C. | |
| 4 | HDPE Blend | PP Copolymer | 206N | 301N | 20.00N | speed 150 m/min, | Polybond |
| | | | | | | rubber roll pressure 7 | 3000 |
| | | | | | | bar, Corona 1.5 kW, | |
| | | | | | | die temp. 280° C. | |
| 5 | HDPE Blend | PP Copolymer | 300N | 306N | 15.00N | speed 200 m/min, | Polybond |
| | | | | | | rubber roll pressure 7 | 3000 |
| | | | | | | bar, Corona 1.5 kW, | |
| | | | | | | die temp. 280° C. | |
| 6 | HDPE Blend | PP Copolymer | 230N | 285N | 15.00N | speed 150 m/min, | Polybond |
| | | | | | | rubber roll pressure 5 | 3000 |
| | | | | | | bar, Corona 1.5 kW, | |
| | | | | | | die temp. 270° C. | |
| 7 | HDPE Blend | PP Copolymer | 214N | 282N | 15.00N | speed 200 m/min, | Polybond |
| | | | | | | rubber roll pressure 5 | 3000 |
| | | | | | | bar, Corona 1.5 kW, | |
| | | | | | | die temp. 270° C. | |
| 8 | HDPE Blend | PP Copolymer | 275N | 281N | 7.96N | speed 200 m/min, | Polybond |
| | | | | | | rubber roll pressure 7 | 3000 |
| | | | | | | bar, Corona 2.0 kW, | |
| | | | | | | die temp. 270° C. | |
| 9 | HDPE Blend | PP Copolymer | 267N | 358N | | speed 200 m/min, | Polybond |
| | | | | | | rubber roll pressure | 3000 |
| | | | | | | 7.5 bar, Corona 2.0 | |
| | | | | | | kW, die temp. 270° C. | |
| 10 | HDPE Blend | PP Copolymer | 277N | 355N | | speed 200 m/min, | Polybond |
| | | | | | | rubber roll pressure 5 | 3000 |
| | | | | | | bar, Corona 2.0 kW, | |
| | | | | | | die temp. 270° C. | |
| 11 | HDPE Blend | PP Copolymer | 214N | 320N | 8.53N | speed 200 m/min, | Polybond |
| | | | | | | rubber roll pressure 5 | 3000 |
| | | | | | | bar, Corona 2.5 kW, | |
| | | | | | | chill roller 16 degrees, | |
| | | | | | | die temp. 270° C. | |
| 12 | HDPE Blend | PP Copolymer | 297N | 350N | 7.25N | speed 200 m/min, | Polybond |
| | | | | | | rubber roll pressure 7 | 7200 |
| | | | | | | bar, Corona 2.5 kW, | |
| | | | | | | die temp. 270° C. | |
| 13 | HDPE Blend | PP Copolymer | 258N | 338N | | speed 200 m/min, | Polybond |
| | | | | | | rubber roll pressure 5 | 7200 |
| | | | | | | bar, Corona 2.0 kW, | |
| | | | | | | die temp. 270° C./ | |
| | | | | | | tapes did not break | |
| 14 | HDPE Blend | PP Copolymer | 454N | | | speed 200 m/min, | Polybond |
| | | | | | | rubber roll pressure 5 | 7200 |
| | | | | | | bar, Corona 2.0 kW, | |
| | | | | | | die temp. 270° C./fold | |
| | | | | | | edge to see at which | |
| | | | | | | strength tapes break | |
| 15 | HDPE Blend | PP Copolymer | 290N | 335N | >800N | speed 200 m/min, | Polybond |
| | | | | | | rubber roll pressure 5 | 7200 |
| | | | | | | bar, Corona 2.5 kW, | |
| | | | | | | chill roller 16 degrees, | |
| | | | | | | die temp. 270° C. | |

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A laminated fabric comprising:
(a) an HDPE-PP blend fabric comprising an HDPE blend fabric cross-woven with polypropylene tape cross material;
(b) a first lamination layer comprising;
(i) polypropylene copolymer having MFI (230° C./2.16 kg) of 22-45; and
(ii) a compatibilizer; and
(c) a polyolefin film layer, wherein the lamination layer binds together the HDPE-PP fabric and the polyolefin film layer.

2. The laminated fabric of claim 1 wherein the HDPE-PP blend fabric is woven.

3. The laminated fabric of claim 1, wherein the cross material is non-woven.

4. The laminated fabric of claim 1, wherein the first lamination layer further comprises (iii) at least one of LDPE and LLDPE having a MFI (190° C./2.16 kg) of 3-10.

5. The laminated fabric of claim 1, further comprising:
(a) a second lamination layer comprising at least one of LDPE, LLDPE, and PP copolymer laminated to the HDPE blend fabric.

6. The laminated fabric of claim 1, wherein the HDPE-PP blend fabric comprises tapes in first and second directions, wherein the tapes of the first direction comprise (I) an oriented polyolefin tape comprising an extruded and stretched melt blend comprising:
(a) 5-35 wt % 0.5-8 MFI (230° C./2.16 kg) polypropylene;
(b) 65-95 wt % 0.1-3.5 MFI (190° C./2.16 kg) high density polyethylene;
(c) 0-30 wt % of at least one filler;
(d) 0-3 wt % of at least one UV additive; and
(e) 0-5 wt % of at least one compatibilizer to form a melt blend; and
(II) the tapes of the second direction are cross tapes comprising a material which has a melt temperature different from the tapes of the first direction.

7. The laminated fabric of claim 6, wherein the tapes of the first direction have a melt temperature in the range of 100 to less than 135° C., and the tapes of the second direction have a melt temperature in the range of greater than 135° C. to 168° C.

8. The laminated fabric of claim 1, wherein the HDPE blend fabric includes a plurality of warp tapes and a plurality of weft tapes, wherein at least one of the (I) plurality of warp tapes and (II) the plurality of weft tapes are cross-woven, wherein:
(a) at least a portion of the warp tapes comprise:
(i) 90-100 wt % homopolymer or copolymer of polypropylene having MFI (230° C./2.16 kg) of 1-6;
(ii) 0-3 wt % of a first filler; and
(iii) 0-3 wt % of a first pigment; and
(b) at least a portion of the weft tapes comprise:
(i) 75-95 wt % 0.05-3 MFI (190° C./2.16 kg) HDPE;
(ii) 10-25 wt % 1-7 MFI (230° C./2.16 kg) polypropylene homopolymer;
(iii) 0-3 wt % of a second filler; and
(iv) 0-3 wt % of a second pigment.

9. The laminated fabric of claim 1, wherein the HDPE blend fabric includes a plurality of warp tapes and a plurality of weft tapes, wherein at least one of (I) the plurality of warp tapes and (II) the plurality of weft tapes are cross-woven, wherein:
(a) at least a portion of the weft tapes comprise:
(i) 90-100 wt % polypropylene copolymer or homopolymer having MFI (230° C./2.16 kg) of 1-6;
(ii) 0-3 wt % of a first filler; and
(iii) 0-3 wt % of a first pigment; and
(b) at least a portion of the warp tapes comprise:
(i) 75-95 wt % HDPE, having MFI (190° C./2.16 kg) 0.05-3;
(ii) 10-25 wt % polypropylene homopolymer having MFI (230° C./2.16 kg) of 1-7;
(iii) 0-3 wt % of a second filler; and
(iv) 0-3 wt % of a second pigment.

10. The laminated fabric of claim 8 wherein at least a portion of the warp tapes comprise polypropylene tapes.

11. The laminated fabric of claim 8 wherein at least one of the first and second fillers is CaCO₃, and wherein at least one of the first and second pigments is TiO₂.

12. The laminated fabric of claim 6, wherein the tape polypropylene has a MFI (230° C./2.16 kg) of 1-7.

13. The laminated fabric of claim 6, wherein the tape high density polyethylene has a MFI (190° C./2.16 kg) of 0.1-3.

14. The laminated fabric of claim 6, wherein the tape polypropylene has a density of 0.89-0.92 g/cc.

15. The laminated fabric of claim 6, wherein the tape high density polyethylene has a density of 0.941-0.997 g/cc.

16. The laminated fabric of claim 1, wherein the polyolefin film layer has a density of 0.7-0.92 g/cc.

17. The laminated fabric of claim 1, wherein the polyolefin film layer has a density of 0.725-0.915 g/cc.

18. The laminated fabric of claim 1, wherein the polyolefin film layer has a density of 0.75-0.91 g/cc.

19. The laminated fabric of claim 1, wherein the polyolefin film layer has a thickness of 8 to 50 microns.

20. The laminated fabric of claim 1, further comprising a tie layer.

21. The laminated fabric of claim 20, wherein the tie layer comprises at least one selected from the group consisting of HDPE, LLDPE, PP, LLDPE-EVA copolymer, anhydride-modified acrylate copolymer and anhydride-modified LLDPE.

22. The laminated fabric of claim 20, wherein the tie layer comprises at least one of an anhydride-modified acrylate copolymer and anhydride-modified LLDPE, wherein the anhydride is selected from the group consisting of acetic anhydride, maleic anhydride and an anhydride having the formula
R¹—C(═O)OC(═O)—R² wherein R¹ and R² are independently C₁-C₁₀ hydrocarbon chains.

23. The laminated fabric of claim 20, wherein the tie layer comprises:
(a) 60-70 wt % polypropylene copolymer having MFI (230° C./2.16 kg) of 22-45;
(b) 10-20 wt % LDPE having MFI (190° C./2.16 kg) of 3-10; and
(c) 15-25 wt % of a compatibilizer.

24. The laminated fabric of claim 1, wherein the polyolefin film layer comprises at least one selected from the group consisting of (a) biaxially oriented polypropylene, (b) a cast film of at least one selected from the group consisting of LDPE, LLDPE, MDPE, HDPE, PP, PET, (c) a blown film of at least one selected from the group consisting of LDPE, LLDPE, MDPE, and HDPE, (d) at least one mono-axially or biaxially oriented film selected from the group consisting of LDPE, LLDPE, MDPE and HDPE and any combination of the foregoing (a), (b), (c) and (d).

25. A method of making a laminated fabric comprising (I) cross-woven oriented polyolefin tapes and (II) a polyolefin film coating, the method comprising:
(a) providing a cross woven HDPE blend fabric and a polyolefin film; and
(b) laminating onto least one side of said HDPE blend fabric the polyolefin film at a temperature of 225-325° C. to form a laminated fabric.

26. The method of claim 25, wherein providing a cross-woven HDPE blend fabric comprises:
(a) melt blending;
(i) 5-35 wt % 0.5-8 MFI (230° C./2.16 kg) PP;
(ii) 65-95 wt % 0.1-3.5 MFI (190° C./2.16 kg) HDPE;
(iii) 0-30 wt % of at least one filler;
(iv) 0-3 wt % of at least one UV additive; and
(v) 0-5 wt % of at least one compatibilizer to form an HDPE-PP melt blend;
(b) extruding the HDPE-PP melt blend at 220-295° C. through a die to form an extrudate;
(c) water quenching the extrudate;
(d) slitting the extrudate to form at least one tape,
(e) heating and stretching the at least one tape at 50-500 m/min and 80-140° C.; and
(f) weaving a plurality of said tapes into a fabric; and
(g) cross-weaving PP homopolymer or PP copolymer tapes into the fabric to form cross-woven HDPE blend fabric.

27. The method of claim 25, further comprising: laminating a second lamination layer comprising LDPE or PP copolymer to the cross-woven HDPE blend fabric.

28. The method of claim 26, wherein the tape PP has a MFI (230° C./2.16 kg) of 1-7.

29. The method of claim 26, wherein the tape HDPE has a MFI (190° C./2.16 kg) of 0.1-3.

30. The method of claim 26, wherein the tape PP has a density of 0.89-0.92 g/cc.

31. The method of claim 26, wherein the tape HDPE has a density of 0.941-0.997 g/cc.

32. The method of claim 26, wherein the polyolefin film layer has a density of 0.7-0.92 g/cc.

33. The method of claim 26, wherein the polyolefin film layer has a density of 0.725-0.915 g/cc.

34. The method of claim 26, wherein the polyolefin film layer has a density of 0.75-0.85 g/cc.

35. The method of claim 26, further comprising laminating a tie layer to the fabric.

36. The method of claim 35, wherein the tie layer comprises at least one selected from the group consisting of HDPE, LLDPE, PP, LLDPE-EVA copolymer, anhydride-modified acrylate copolymer and anhydride-modified LLDPE.

37. The method of claim 35, wherein the tie layer comprises at least one of an anhydride-modified acrylate copolymer and anhydride-modified LLDPE, wherein the anhydride is selected from the group consisting of acetic anhydride, maleic anhydride and an anhydride having the formula R¹—C(═O)OC(═O)—R² wherein R¹ and R² are independently C₁-C₁₀ hydrocarbon chains.

38. The method of claim 35, wherein the tie layer comprises:
(a) 60-70 wt % polypropylene copolymer having MFI (230° C./2.16 kg) of 22-45;
(b) 10-20 wt % LDPE having a MFI (190° C./2.16 kg) of 3-10; and
(c) 15-25 wt % of a compatibilizer.

39. A laminated fabric comprising:
(a) a cross woven HDPE blend fabric;
(b) a first lamination layer comprising;
(i) polypropylene copolymer having a MFI (230° C./2.16 kg) of 22-45; and
(ii) a compatibilizer; and
(c) a tie layer, wherein the tie layer comprises at least one selected from the group consisting of HDPE, LLDPE, PP, LLDPE-EVA copolymer, anhydride-modified acrylate copolymer and anhydride-modified LLDPE.

40. The laminated fabric of claim 39, wherein the tie layer comprises at least one of an anhydride-modified acrylate copolymer and anhydride-modified LLDPE, wherein the anhydride is selected from the group consisting of acetic anhydride, maleic anhydride and an anhydride having the formula R¹—C(═O)OC(═O)—R² wherein R¹ and R² are independently C₁-C₁₀ hydrocarbon chains.

41. The laminated fabric of claim 39 wherein the tie layer comprises:
(a) 60-70 wt % polypropylene copolymer having MFI (230° C./2.16 kg) of 22-45;
(b) 10-20 wt % LDPE having a MFI (190° C./2.16 kg) of 3-10; and
(c) 15-25 wt % of a compatibilizer.

42. A laminated cross woven fabric comprising:
(a) a cross-woven HDPE blend fabric;
(b) a first lamination layer laminated to a first side of the HDPE blend fabric, the lamination layer comprising:
(i) 70-100% of 5-10 MFI (190° C./2.16 kg) LDPE or LLDPE; and
(ii) 0-30% of 22-45 MFI (230° C./2.16 kg) polypropylene copolymer;
(c) a tie layer laminated to a second side of the blend fabric, the tie layer comprising:
(i) 22-45 MFI (230° C./2.16 kg) polypropylene copolymer;
(ii) a compatibilizer; and
(iii) at least one selected from the group consisting of from the group consisting of HDPE, LLDPE, PP, LLDPE-EVA copolymer, anhydride-modified acrylate copolymer and anhydride-modified LLDPE; and
(d) a polyolefin film layer bonded to the tie layer.

43. A laminated cross-woven fabric comprising:
(a) a cross-woven HDPE blend fabric;
(b) a lamination layer comprising:
(i) 0-100% 5-10 MFI (190° C./2.16 kg) LDPE or LLDPE;
(ii) 0-100% 22-45 MFI (230° C./2.16 kg) PPCP;
(iii) 0-10% of a filler; and
(iv) 0-4% of a pigment.

44. A shipping sack comprising a laminated fabric of claim 1.

45. A shipping sack comprising a laminated fabric made by the method of claim 25.

46. A method for laminating a first film to a second film to form a composite laminated film, the method comprising:
simultaneously conveying a first film onto a nip roll and a second film onto a laminating roll;
pressing the first film into contact with the second film between the nip roll and the laminating roll to form the composite laminated film, said composite laminated film having a first film side facing away from the laminating roll and a second film side in contact with the laminating roll;
conveying the composite laminated film from the laminating roll onto an intermediate roll, wherein the first film side contacts the intermediate roll and the second film side faces away from the intermediate roll;
conveying the composite laminated film from the intermediate roll onto a return roll, wherein the second film side contacts the return roll and the first film side faces away from the return roll;
conveying the composite laminated film from the return roll onto the laminating roll, wherein the second film side contacts the laminating roll and the first film side faces away from the laminating roll; and
conveying the composite laminated film from the laminating roll onto a discharge roll, wherein the first film side contacts the discharge roll and the second film side faces away from the discharge roll.

47. The method according to claim 46, wherein the laminating roll has a larger diameter than the intermediate roll.

48. The method according to claim 47, wherein the return roll has a smaller diameter than the intermediate roll.

49. The method according to claim 47, wherein the return roll has the same diameter as the intermediate roll.

50. The method according to claim 46, wherein the laminating roll is cooled.

51. The method according to claim 46, wherein at least one of the intermediate roll and the return roll are cooled.

52. The method according to claim 46, wherein the first film comprises a polyolefin and the second film comprises polyethylene.

53. A film lamination station comprising:
a nip roll;
a laminating roll;
an intermediate roll;
a return roll; and
a discharge roll;
wherein the nip roll is configured to press a first film conveyed thereon into contact with a second film conveyed by the laminating roll to form a composite laminated film having a first film side facing away from the laminating roll and a second film side in contact with the laminating roll,
wherein the intermediate roll is configured to receive the laminated film from the laminating roll with the first film side in contact with the intermediate roll and the second film side facing away from the intermediate roll,
wherein the return roll is configured to receive the laminated film from the intermediate roll with the second film side in contact with the return roll and the first film side facing away from the return roll,
wherein the laminating roll is configured to receive the laminated film from the return roll with the second film side in contact with the laminating roll and the first film side facing away from the laminating roll, and
wherein the discharge roll is configured to receive the laminated film from the laminating roll with the first film side in contact with the discharge roll and the second film side facing away from the discharge roll.

54. The film lamination station according to claim 53, wherein the laminating roll has a larger diameter than the intermediate roll.

55. The film lamination station according to claim 54, wherein the return roll has a smaller diameter than the intermediate roll.

56. The film lamination station according to claim 54, wherein the return roll has the same diameter as the intermediate roll.

57. The film lamination station according to claim 53, wherein the laminating roll is cooled.

58. The film lamination station according to claim 53, wherein at least one of the intermediate roll and the return roll are cooled.

59. The film lamination station according to claim 53, wherein the first film comprises a polyolefin and the second film comprises polyethylene.

60. A shipping sack comprising the composite laminated film made by the method of claim 46.
